(19) United States
(12) Patent Application Publication
(10) Pub. No.: US 2014/0322017 A1
(43) Pub. Date: Oct. 30, 2014

(54) ROTARY MECHANICAL SYSTEM WITH CONTACTLESS ACTUATION

(71) Applicant: HISPANO SUIZA, Colombes (FR)

(72) Inventors: Cedric Duval, Samois Sur Seine (FR); Eric De Wergifosse, Saint Augustin (FR); Vincent Hidelot, Savigny Le Temple (FR)

(73) Assignee: HISPANO SUIZA, Colombes (FR)

(21) Appl. No.: 14/357,623

(22) PCT Filed: Nov. 23, 2012
(86) PCT No.: PCT/FR12/52710

§ 371 Date: May 12, 2014

(30) Foreign Application Priority Data
Nov. 24, 2011 (FR) 11 60764

(51) Int. Cl. F01D 7/00

(52) U.S. Cl. CPC F01D 7/00; F05D 2270/023; F05D 2270/62
USPC 416/147

(57) ABSTRACT

A mechanical system including: a shaft rotatably mounted about a primary axis thereof in relation to a structural element; a movable member mounted on the shaft to be fixed to the shaft for rotation therewith about the primary axis and configured to be moved selectively in relation to the shaft; a drive mechanism moving the movable member in relation to the shaft, and including a first fixed portion mounted on the structural element, a second movable portion mounted on the shaft and connected to the movable member, and an air gap electromechanical actuator between the first portion and the second portion.

### FIELD OF THE INVENTION

The invention relates to a rotary electromechanical system comprising a member mounted on a movable shaft, which is suitable for being moved in relation the movable shaft.

The electromechanical system comprises a frictionless drive device wherein one component is movable in relation to the movable shaft, for which the service life of the drive device is enhanced by reducing friction between moving parts.

### STATE OF THE RELATED ART

In a rotary mechanical system such as for example a turbine engine comprising a variable blade pitch alignment mechanism, the blades are borne by a shaft rotatably mounted about the primary axis thereof.

Each blade is further movably mounted in relation to the shaft about a radial axis in relation to the main shaft axis, to modify the blade pitch.

The blades are rotated by means of a drive system which is connected to the blades and wherein one part is mounted on the structural element of the turbine engine.

According to known examples of embodiments, the means for driving the blades consist of rotary seal hydraulic systems or rotary contact electrical of electronic systems.

Such embodiments comprise numerous movable elements which are in contact with each other. This results in component wear and significant heat production. In this way, the mechanical system also comprises cooling and lubrication means for limiting the heating and wear of these components. Also, it is sometimes necessary to perform regular maintenance operations of the mechanical system.

The aim of the invention is that of providing a mechanical system for which the means for moving the blades in relation to the shaft are embodied so as to limit friction between the movable elements.

### DESCRIPTION OF THE INVENTION

The invention relates to a mechanical system comprising:
a shaft which is rotatably mounted about the primary axis thereof in relation to a structural element;
a movable member which is mounted on the shaft such that it is fixed to the shaft for rotation therewith about the primary axis and such that it is suitable for being moved selectively in relation to the shaft;
drive means for moving the movable member in relation to the shaft comprising a first fixed portion which is mounted on the structural element and a second movable portion which is mounted on the shaft and which is connected to the movable member,
characterised in that the drive means consist of an air gap electromechanical actuator between the first portion and the second portion.

The air gap between the two portions of the actuator make it possible to eliminate any contact between the elements connected to the structural element and the elements which are movable in relation to the structural element, thus reducing friction.

Preferably, the drive means consist of a radial field air gap electromechanical actuator.

Preferably, the drive means consist of an axial field air gap electromechanical actuator.

Preferably, the second portion of the drive means is rotatably mounted coaxially with the shaft and is connected to the shaft by means for guiding in rotation about the primary axis of the shaft.

Preferably, the mechanical system comprises means for converting the rotary motion of the second portion in relation to the shaft into a movement of the movable member in relation to the shaft which comprise a motion input member connected to the second portion, said motion input member being selectively rotatable in relation to the shaft during the movement of the movable member.

Preferably, the mechanical system comprises means for controlling the drive means to control the rotational speed of the second portion of the drive means in relation to the first portion, according to the rotational speed of the shaft.

Preferably, the control means are embodied so as to cause rotation of the motion input member about the shaft to move the movable member in relation to the shaft.

Preferably, the movable member is rotatably mounted in relation to the shaft about a secondary axis (B) having a radial orientation in relation to the primary axis, said secondary axis (B) being fixed to the shaft for rotation therewith about the primary axis.

The invention also relates to an aircraft turbine engine characterised in that it comprises a mechanical system according to any of the above claims, wherein the movable member consists of a variable orientation blade.

Preferably, the turbine engine comprises a plurality of blades distributed about the primary axis of the shaft.

### BRIEF DESCRIPTION OF THE FIGURES

FIG. 1 is a schematic representation of a mechanical system according to the invention;

FIG. 2 is a similar view to that in FIG. 1, showing a second embodiment of the means for converting motion;

FIG. 3 is a detailed schematic representation of a mechanical system according to the invention for which the drive means consist of a magnet asynchronous or asynchronous motor;

FIG. 4 is a similar view to that in FIG. 3, wherein the drive means consist of a field coil synchronous motor;

FIG. 5 is a similar view to that in FIG. 3, wherein the drive means consist of an axial air gap synchronous motor.

### DETAILED DESCRIPTION OF PARTICULAR EMBODIMENTS

The figures represent a mechanical system 10 such as a turbine engine rotor comprising a rotatable shaft 12 about the primary axis A thereof, in relation to a structural element 14 of the turbine engine. This structural element may in turn be fixed in the turbine engine, or it may be movable in the turbine engine. For the purposes of clarity, the structural element 14 will be considered to be fixed in relation to the shaft 12.

The shaft bears a plurality of blades 16 which are distributed evenly about the shaft 12 in relation to the primary axis A and which are fixed to the shaft 12 for rotation therewith in relation to the structural element 14, about the primary axis A.

The mechanical system 10 comprises means for setting the pitch of the blades 16 in order to adapt the system to the operating conditions of the turbine engine.

In this way, each blade 16 is movably mounted in relation to the shaft 12 about a secondary axis B having a radial main orientation in relation to the primary axis A. Each secondary axis B is a primary axis of the associated blade 16, it is thus fixed to the shaft 12 for rotation therewith about the primary axis A.

The means for setting the pitch of the blades 16 comprise drive means 18 for rotating each blade 16 about the associated secondary axis B.

The drive means essentially comprise a first fixed portion 20 which is attached to the structural element 14 and a second movable portion 22 which is connected to each blade 16.

The second portion is rotatably mounted in relation to the structural element 14 about the primary axis A.

Herein, the first portion 20 and the second portion 22 are coaxial to the shaft 12 and consist of two rotating elements superposed radially on the shaft 12.

The drive means 18 consist of an air gap electromechanical actuator. This means that a gap is present between the fixed portion 20 and the movable portion 22.

In this way, there is no mechanical contact between the fixed portion 20 and the movable portion.

The movable portion 22 is rotated in relation to the fixed portion 20 by means of electromagnetic forces requiring no contact between the two portions 20, 22.

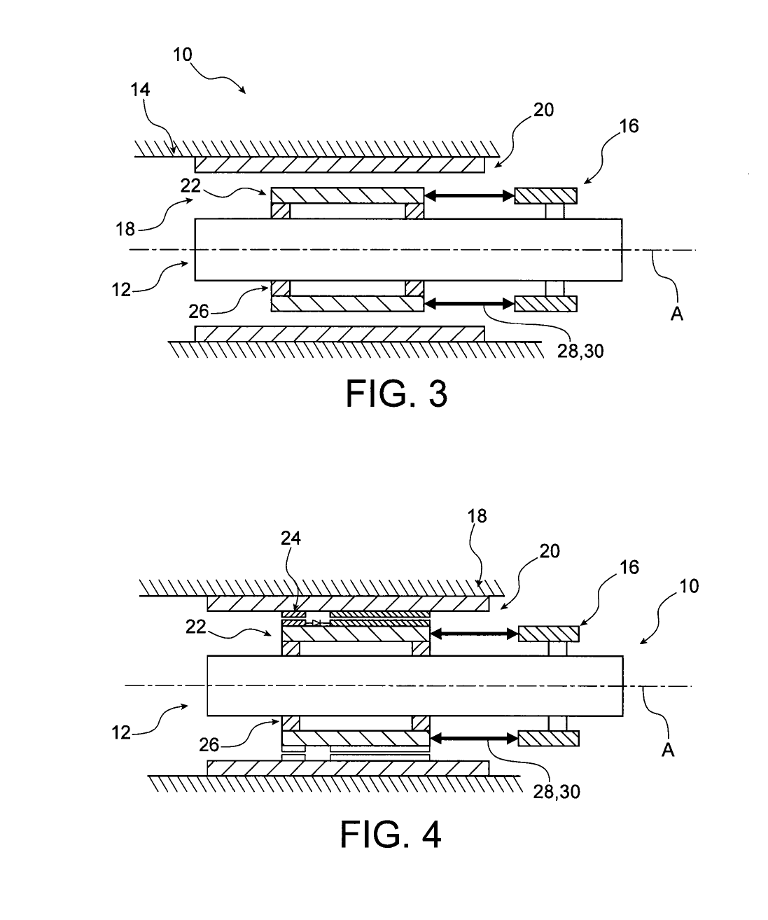

According to a first embodiment represented in FIG. 3, the drive means 18 consist of a permanent magnet synchronous motor.

According to this embodiment, the movable portion 22 bears one or a plurality of permanent magnets (not shown) and the fixed portion 20 comprises means for producing an electromagnetic field inducing the rotation of the movable portion bearing the permanent magnet(s).

According to a second embodiment represented in FIG. 4, the drive means 18 consist of a field coil synchronous motor.

According to this embodiment, the movable portion 22 bears one or a plurality of windings which are supplied with electrical current so as to act as one or a plurality of electromagnets.

According to the invention, in order to eliminate any electrical contact between the fixed portion 20 and the movable portion 22, the movable portion 22 is powered by means of a current induction system 24 which is also of the contactless type.

According to a further embodiment, the drive means 18 consist of an asynchronous motor.

During the operation of the mechanical system 10, the shaft 12 and the movable portion 22 both rotate about the primary axis A.

The mechanical system 10 is embodied such that the second portion 22 is suitable for rotating at a different speed to the rotational speed of the shaft 12 to enable the movement of the blades 16.

In addition, since there is no contact between the second portion 22 and the first portion 20, and more generally between the second portion 22 and the structural element 14, the second portion 22 is guided in rotation about the primary shaft A by means 26 for linking the second portion 22 with the shaft 12 which are means for guiding the second portion 22 in rotation in relation to the shaft 12 about the primary axis A.

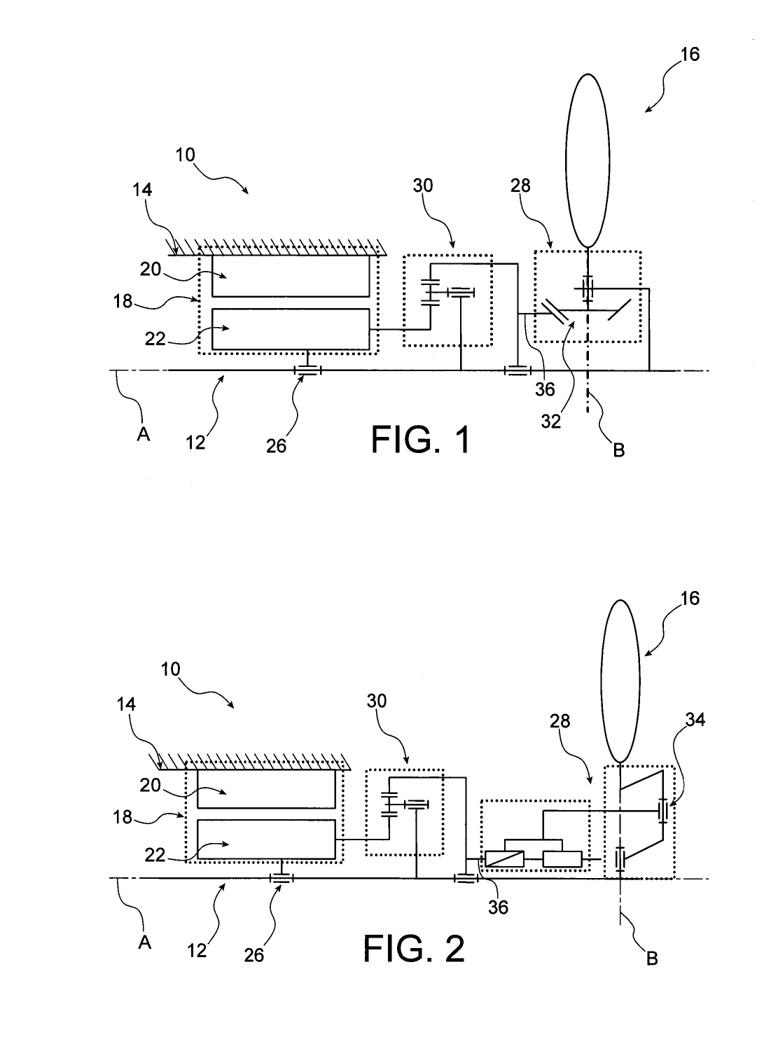

As can be seen in FIGS. 1 and 2, the second portion 22 of the drive means 18 is further connected to the blades 16 via motion conversion means 28.

The motion conversion means 28 are mounted on the shaft 12 such that they are fixed to the shaft 12 for rotation therewith about the primary axis A. The motion conversion means 28 comprise a motion input member 36 which is connected to the second portion 22 of the drive means 18. The motion conversion member 36 is suitable for rotating selectively about the shaft 12 according to the rotational speed of the second portion 22 of the drive means 18 about the primary axis A.

The motion conversion means 28 are embodied such that when the motion input member 36 rotates in relation to the shaft 12, each blade 16 rotates about the associated secondary axis B.

According to the embodiment represented in FIG. 1, the motion conversion means 28 are of the type comprising a bevel gear coupling 32.

According to the embodiment represented in FIG. 2, the motion conversion means 28 are of the type comprising a crankshaft system 34.

Herein, the motion input member 36 is connected to the second portion 22 of the drive means 18 via a gear system 30 for modifying the rotational speed of the motion input member 36 about the primary axis A in relation to the rotational speed of the second portion 22 about the primary axis A.

The gear ratio of this gear system 30 is determined so as to reduce or increase the rotational speed of the second portion 22, according to the type of actuator forming the drive means 18 and according to the rotational speed ranges of the shaft 12.

According to one alternative embodiment, the second portion 22 of the drive means 18 is connected directly to the motion input member 36.

The drive means 18 also comprise regulation means (not shown) which are designed to regulate the rotational speed of the second portion 22 in relation to the structural element 14 according to the rotational speed of the shaft 12 in relation to the structural element 14 and according to the gear ratio of the gear system 30.

The regulation means are embodied so as to selectively induce rotation of the motion input member in relation to the shaft 12, when the orientation of the blades 16 needs to be modified.

Indeed, during the operation of the mechanical system 10, and when the blades 16 should not move in relation to the shaft 12, the motion input member 36 should remain immobile in relation to the shaft 12, i.e. it rotates at the same speed as the shaft 12 in relation to the structural element 14.

In this way, the rotational speed of the second portion 22 in relation to the structural element 14 is defined so that the rotational speed of the motion input member 36 in relation to the structural element 14 is equal to the rotational speed of the shaft 12 in relation to the structural element 14.

However, when the orientation of the blades 16 is to be modified, the regulation means modify the rotational speed of the second portion 22 in relation to the structural element 14 for a certain time so that the motion input member 36 rotates in relation to the shaft 12 by a predefined angle corresponding to the modification of angular position of each blade 16.

The modification of the rotational speed of the second portion 22 in relation to the structural element 14 may consist of an increase, decrease or inversion of the rotational speed of the second portion 22.

When the sought angular position of each blade 16 is obtained, the regulation means modify the rotational speed of the second portion 22 in relation to the structural element 14 so that the motion input member 36 rotates at the same speed as the shaft 12 in relation to the structural element 14 and thus so that the motion input member 36 is immobile in relation to the shaft 12.

As a non-limiting example, wherein the drive means 18 consist of a permanent magnet synchronous motor, the power supply frequency at the fixed portion 20 should offset the rotational speed of the shaft 12 in relation to the primary axis A.

The reference “F12” is thus defined as being the differential rotation frequency of the shaft 12 in relation to the first portion 20 (for example for a rotational speed of the shaft 12 in relation to the primary axis A of 1200 rpm, this corresponds to a frequency F12 of 20 Hz).

The reference “p” is also defined as being the number of pair of poles of the magnet synchronous motor.

To obtain a relative rotation frequency “F22” of the second portion 22 in relation to the shaft 12, a power supply frequency of the magnet synchronous motor of p*(F12+F22) would be required.

For a magnet synchronous motor having 3 pole pairs and a maximum drive speed of 10,200 rpm, a maximum power supply frequency of 3*(20 Hz+170 Hz)=570 Hz is obtained.

In the event of the use of an asynchronous motor, the power supply is defined by the formula p*(F12+F22+Fr) where Fr is the rotor current frequency in the second portion 22.

Fr varies according to the torque applied and the operating point.

For an asynchronous motor having 3 pole pairs and a maximum drive speed of 1200 rpm, for example under steady conditions, a maximum power supply frequency of 3*(20 Hz+170 Hz+10 Hz)=600 Hz is obtained.

It will be understood that the rotational speed of the second portion 22 may be modified continuously, to prevent any jerking.

According to the embodiments represented in FIGS. 1 to 4, the drive means 18 are of the radial field air gap type, i.e. the fixed portion 20 and the movable portion 22 are coaxial and are radially offset in relation to each other.

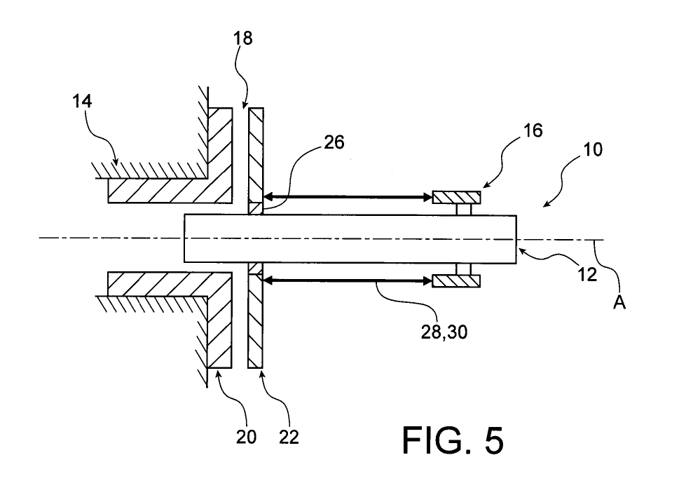

It will be understood that the invention is not limited to this embodiment and that the drive means 18 may be of another type, such as for example represented in FIG. 5 wherein the drive means are of the axial field air gap type.

According to this embodiment, the fixed portion 20 and the movable portion 22 are axially offset in relation to each other.

According to a further embodiment (not shown), the drive means 18 are of the type combining a radial field air gap and an axial field air gap.

In addition, the invention has been described in associated with turbine engine blades 16 which are rotatable about the secondary axis B. It will be understood that the invention is not limited to this embodiment and that the invention may be associated with any element movably mounted along the secondary axis B in translation along the second axis B or according to motion combining translation and rotation in relation to the secondary axis B.

1-9. (canceled)

10. A mechanical system comprising:
a shaft rotatably mounted about a primary axis thereof in relation to a structural element;
a movable member mounted on the shaft to be fixed to the shaft for rotation therewith about the primary axis and to be configured to be moved selectively in relation to the shaft;
drive means for moving the movable member in relation to the shaft and comprising a first fixed portion mounted on the structural element, a second movable portion mounted on the shaft and which is connected to the movable member, and an air gap electromechanical actuator between the first portion and the second portion; and
means for controlling the drive means to control a rotational speed of the second portion of the drive means in relation to the first portion, according to a rotational speed of the shaft.

11. A mechanical system according to claim 10, wherein the drive means comprises a radial field air gap electromechanical actuator.

12. A mechanical system according to claim 10, wherein the drive means comprises an axial field air gap electromechanical actuator.

13. A mechanical system according to claim 10, wherein the second portion of the drive means is rotatably mounted coaxially with the shaft and is connected to the shaft by means for guiding in rotation about the primary axis of the shaft.

14. A mechanical system according to claim 13, further comprising means for converting rotary motion of the second portion in relation to the shaft into a movement of the movable member in relation to the shaft and which comprises a motion input member connected to the second portion, the motion input member being selectively rotatable in relation to the shaft during movement of the movable member.

15. A mechanical system according to claim 10, wherein the control means causes rotation of the motion input member about the shaft to move the movable member in relation to the shaft.

16. A mechanical system according to claim 10, wherein the movable member is rotatably mounted in relation to the shaft about a secondary axis having a radial orientation in relation to the primary axis, the secondary axis being fixed to the shaft for rotation therewith about the primary axis.

17. An aircraft turbine engine comprising a mechanical system according to claim 10, wherein the movable member includes a variable orientation blade.

18. A turbine engine according to claim 17, comprising a plurality of blades distributed about the primary axis of the shaft.
